(19) United States
(12) Patent Application Publication
(10) Pub. No.: US 2022/0258636 A1
(43) Pub. Date: Aug. 18, 2022

(54) METHOD AND DEVICE FOR CHARGING AN ELECTRICALLY DRIVEN VEHICLE

(71) Applicant: Lisa Draexlmaier GmbH, Vilsbiburg (DE)

(72) Inventor: Stephan SCHAFFERHANS, Muenchen (DE)

(73) Assignee: Lisa Draexlmaier GmbH, Vilsbiburg (DE)

(21) Appl. No.: 17/737,609

(22) Filed: May 5, 2022

Related U.S. Application Data
(63) Continuation of application No. PCT/EP2020/080500, filed on Oct. 30, 2020.

(30) Foreign Application Priority Data
Nov. 5, 2019 (DE) 10 2019 129 799.0

(51) Int. Cl. B60L 53/62; H02J 7/00

(52) U.S. Cl. CPC B60L 53/62; H02J 7/0047; H02J 7/00309; B60L 53/14; H02J 7/007192; H02J 2310/48; H02J 7/00712

(57) ABSTRACT

A method for charging an electrically powered vehicle includes predetermining a maximum charging current of a charging process for charging the vehicle before the start of the charging process based on an electrical resistance of at least one interface component of an interface between a charging device and the vehicle. The electrical resistance is determined during at least one previous charging process. The method further includes charging the electrically powered vehicle based on the predetermined maximum charging current.

### CROSS-REFERENCE TO RELATED APPLICATIONS

This application is a continuation of International Application No. PCT/EP2020/080500, filed on Oct. 30, 2020, which claims priority to and the benefit of DE 10 2019 129 799.0, filed on Nov. 5, 2019. The disclosures of the above applications are incorporated herein by reference.

### FIELD

The present disclosure relates to a method and a device for charging an electrically powered vehicle.

### BACKGROUND

The statements in this section merely provide background information related to the present disclosure and may not constitute prior art.

In order to rapidly charge a traction battery of an electrically powered vehicle, a high electrical charging power is required. Since an electrical voltage of the traction battery is fixed, a high electrical current flow results in a current path for rapid charging of the traction battery. The current flow causes a heating of current-carrying components of the current path.

The components require a sufficiently dimensioned line cross-section in order to achieve a low electrical resistance and to limit the heating within acceptable values during rapid charging.

A charging jack of the vehicle and a charging plug of a charging device form a plugged interface in the current path. In one form due to changes on surfaces of the charging jack and of the charging plug, a contact resistance can arise at the interface during rapid charging that can lead to a greater heating of the interface than in the rest of the current path.

In order to reduce damage to the interface, temperatures of the charging jack and of the charging plug can be monitored, and in the event of exceeding of a certain temperature threshold the charging power can be reduced, i.e., the current flow can be limited.

### SUMMARY

This section provides a general summary of the disclosure and is not a comprehensive disclosure of its full scope or all of its features.

In one form, the present disclosure includes a method and a device for charging an electrically powered vehicle.

In one form, the present disclosure includes a method for charging an electrically powered vehicle includes predetermining a maximum charging current of a charging process for charging the vehicle before the start of the charging process based on an electrical resistance of at least one interface component of an interface between a charging device and the vehicle. The electrical resistance is determined during at least one previous charging process, The method further includes charging the electrical powered vehicle based on the predetermined maximum charging current.

A charging of the vehicle can be understood to mean a charging of a traction battery of the vehicle. A releasable interface can be disposed between a charging device and the traction battery. A charging jack and a charging plug can be interface components of the interface. The interface components can be plugged together and released again. The interface components can include a plurality of plug connectors. A charging cable can be disposed between the charging device and the vehicle. The charging cable can include at least one forward line and one return line for the transmission of electricity. The charging cable can also include data lines and signal lines. The lines can be electrically conductively connected to the interface and separated again. The charging cable can be a component of the charging device and be plugged into the vehicle via the interface. The charging cable can also be connected to the charging device via a first interface on the vehicle, as well as via a second interface on the charging device. Then at least two interfaces are disposed between the charging device and the traction battery. The approach presented here can be used on any interface. The charging device can be embodied, in one form, as a wall box or as a charging station.

A charging process can be a period wherein the interface components are connected to each other and a charging current flows over the forward line and the return line. The charging current is an electrical current flow for the transmitting of electrical power from the charging device to the traction battery or charging electronics of the traction battery. A maximum charging current can be a predefined maximum value for the charging current. The maximum charging current limits the maximum possible transmitted power. An actual charging current can be lower than the maximum charging current.

The maximum charging current can also be predetermined when the electrical resistance of only one of the interface components is known. Thus, in one form, a vehicle that uses the approach presented here can also be charged on a conventional charging device. Conversely, a conventional vehicle can thus be charged on a charging device that uses the approach presented here.

The maximum charging current can be predetermined based on the resistance of at least one interface component of the charging device and the resistance of at least one interface component of the vehicle. When the interface is disposed between the cable and the vehicle, the maximum charging current can be predetermined based on the resistance of at least one interface component of the cable and the resistance of at least one interface component of the vehicle. When the interface is disposed between the cable and the charging device, the maximum charging current can be predetermined based on the resistance of at least one interface component of the cable and the resistance of at least one interface component of the charging device. The maximum charging current can be predetermined based on the two different resistances of the mutually connected interface components. Since the vehicle can be charged on different charging devices, different maximum charging currents can also be predetermined on the different charging devices. Likewise, different vehicles can be charged on the same charging device, and different maximum charging currents can be predetermined on the same charging device for different vehicles. Due to the use of the resistances of both interface components, the maximum charging current can be predetermined with an increased accuracy.

A resistance determination for determining the current electrical resistance of the interface can be carried out via the interface during the current charging process using a current temperature of the interface and of a current charging current. The determined resistance can be used for a subsequent charging process. By a determining of the resistance during the charging process, the stored resistance value used for limiting the charging current, an aging of the interface or at least one of the interface components can be tracked. The resistance can be determined using a model. The model can be based on measurements of the resistance with defined framework conditions. The model can use the current temperature of at least one of the interface components and the current charging current as input values, and the estimated electrical resistance as output value.

The resistance of the interface can be determined using a vehicle resistance value, provided by the vehicle, representing an estimated electrical resistance of an interface component of the vehicle, and a charging device resistance value, provided by the charging device, representing an estimated electrical resistance of an interface component of the charging device. Resistance values can be stored from charging process to charging process. The estimated resistances of the interface components can be added. By changing partners at the interface, another maximum charging current can respectively be predetermined.

The current electrical resistance of the interface component of the vehicle can be estimated using the current electrical resistance of the interface and of the charging device resistance value, stored in the charging device, of the previous charging process. The current electrical resistance of the interface component of the vehicle can be estimated in the charging device. All values required for this purpose are present in the charging device. The current electrical resistance of the interface component of the vehicle can be reproduced in an updated vehicle resistance value and provided by the charging device for the vehicle. The vehicle resistance value can be provided via the interface. The vehicle resistance value can also be provided via another communication path. The vehicle resistance value stored in the vehicle can be updated during the current charging process using the estimated electrical resistance of the interface component of the vehicle.

The current electrical resistance of the interface component of the charging device can be estimated using the current electrical resistance of the interface and of the vehicle resistance value, stored in the vehicle, of the previous charging process. The current electrical resistance of the interface component of the charging device can be estimated in the vehicle. All values required for this purpose are present in the vehicle. The current electrical resistance of the interface component of the charging device can be reproduced in an updated charging device resistance value and provided by the vehicle for the charging device. The charging device resistance value can be provided via the interface. The charging device resistance value can also be provided via another communication path. The charging device resistance value stored in the charging device can be updated during the current charging process using the estimated electrical resistance of the interface component of the charging device.

The method can be implemented, in one form, in software or hardware, or in a hybrid of software and hardware, in one form, in a control device.

The approach presented here further provides a control device that is configured to carry out, control, or implement steps of a variant of the method presented here in corresponding devices.

The control device can be an electrical device including at least one computing unit for the processing of signals or data, at least one storage unit for the storing of signals or data, and at least one interface and/or one communication interface for the reading or outputting of data that are embedded in a communication protocol. The computing unit can be, in one form, a signal processor, a so-called system ASIC, or a microcontroller for the processing of sensor signals and outputting of data signals in a manner dependent on the sensor signals. The storage unit can be, in one form, a flash storage, an EPROM, or a magnetic storage unit. The interface can be configured as a sensor interface for the reading of the sensor signals from a sensor and/or as an actuator interface for the outputting of the data signals and/or control signals to an actuator. The communication interface can be configured to read or output the data in a wireless or wired manner. The interfaces can also be software modules that are present, in one form, on a microcontroller in addition to other software modules.

Also advantageous is a computer program product or computer program including program code that can be stored on a machine-readable carrier or storage medium, such as a semiconductor storage, a hard disk storage, or an optical storage and is used for carrying out, implementing, and/or controlling the steps of the method according to one of the above-described forms, in one form, when the program product or program is carried out on a computer or a device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a representation of an interface between a first interface component and a second interface component, according to the teachings of the present disclosure; and

FIG. 2 shows a representation of a charging process using a method according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

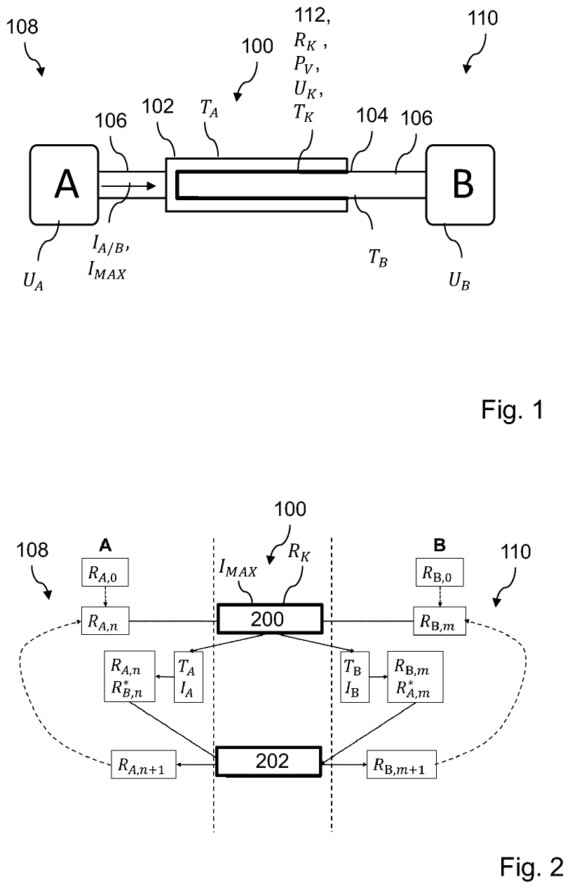

For easier understanding, in the following description the reference numbers are maintained as reference with respect to FIGS. 1-2.

FIG. 1 shows a representation of an interface 100 between a first interface component 102 and a second interface component 104 of the interface 100. The interface 100 is disposed in a line 106 between two participants A, B of a charging process. The participant A can be, in one form, a charging device 108, and the participant B can be a traction battery of a vehicle 110. Likewise, the participant A can be the traction battery of the vehicle 110, and the participant B the charging device 108. Each participant A, B includes a control device, not depicted here, for the controlling of the charging process. The control devices are configured to exchange data with one another and to predetermine a maximum charging current I_{MAX} via the interface 100, prior to the start of the charging process, in a manner dependent on an aging state of the interface components 102, 104.

The interface components 102, 104 are configured as plug connectors. Here, the first interface component 102 is configured, in one form, as a jack, while the second interface component 104 is configured as a plug. For simplification only one line 106 of the interface 100 is depicted here. The interface 100 can include a plurality of further lines 106. The interface 100 can include at least one forward line and one return line for the transmitting of an electrical charging power for the charging of the traction battery.

An electrical current flow I_{A/B} flows through the line 106, via a contact surface 112, between the interface components 102, 104. Due to a contact resistance R_{K} at the contact surface 112, an electrical voltage U_{K} decreases at the contact surface 112, and the contact surface 112 heats due to a resulting power loss P_{V}. A different electrical voltage U_{A}, U_{B}, in one form, can therefore be measured at each of the participants A, B. The electrical current flow I_{A/B} at the participants A, B remains the same. Here the electrical current flow I_{A/B} can be measured separately at the two participants A, B. Due to measurement inaccuracies, slightly different values result here for the electrical current flow I_{A/B} over the interface 100.

The interface components 102, 104 are temperature-monitored. A first temperature value T_{A} is recorded at the first interface component 102. A second temperature value T_{B} is recorded at the second interface component 104. Since the temperature values T_{A}, T_{B} are not measured directly at the contact surface 112, a temperature T_{K} of the contact surface 112 can deviate from the temperature values T_{A}, T_{B}.

Using the present measurement values, the contact resistance R_{K} and the power loss P_{V} can be calculated.

The contact resistance R_{K} is dependent on a state of the contact surface 112. The state of the contact surface 112 is in turn determined by states of surfaces of the interface components 102, 104, which surfaces form the contact surface 112. For example, the surfaces can age due to environmental influences and be at least partially covered by oxide layers that have a high electrical resistance. Likewise, a coating of the surfaces, which coating improves the contact resistance R_{K}, can be mechanically and/or thermally damaged. The coatings can be damaged, in one form, when, due to a too-high current flow I_{A/B} over the interface 100, the temperature T_{K} of the contact surface 112 increases at least locally above a damage value, even for a short time. Due to the temperature values T_{A}, T_{B} this exceeding can only be depicted with a delay, whereby the coating may already be damaged when the temperature values T_{A}, T_{B} have correspondingly high values.

Due to the approach presented here, such an exceeding of the temperature T_{K} of the contact surface 112 can be proactively inhibited by the maximum charging current I_{MAX} for the current charging process being predetermined, taking into account the contact resistance R_{K} determined during a previous charging process.

FIG. 2 shows a representation of a charging process 200 using a method according to one form. The method can be used, in one form, at an interface, as is depicted in FIG. 1. During the charging process 200, the maximum charging current I_{MAX} of the charging process 200 for the charging of the vehicle 110 is predetermined prior to the start of the charging process 200, based on the electrical resistance R_{A/B}, determined during at least one previous charging process, of at least one interface component A, B of the interface 100 between a charging device 108 and the vehicle 110. The previous charging process has been completed prior to the start of the current charging process 200. Here, the interface 100 has been separated between the previous charging process and the current charging process 200. The vehicle 110 can have been moved between the charging processes. In one form, the previous charging process has been carried out in combination with another charging device or another vehicle. The interface 100 is also separated between the current charging process 200 and a subsequent charging process.

Here the resistance R_{A/B} is composed of an electrical resistance R_{A} of the first interface component A and an electrical resistance R_{B} of the second interface component B. Here the charging device 108 provides a charging device resistance value R_{A,n} representing the electrical resistance R_{A} of the first interface component A during a previous charging process, while the vehicle 110 provides a vehicle resistance value R_{B,m} representing the electrical resistance R_{B} of the second interface component B during a previous charging process. The resistance values R_{A,n}, R_{B,m} are combined, and the maximum charging current I_{MAX} is predetermined for the current charging process 200.

During the current charging process 200, an actual current flow I_{A} and a temperature T_{A} of the first interface component A are recorded in the charging device. Using a model of the interface 100, the current resistance R_{K} of the interface is estimated therefrom during the current charging process 200. Since the charging device resistance value R_{A,n} is known, using the current resistance R_{K} an estimated vehicle resistance value R_{B,n} depicting the estimated electrical resistance R_{B} of the second interface component B during the current charging process 200 can be determined.

During the current charging process 200, an actual current flow I_{B} and a temperature T_{B} of the second interface component B are recorded in the vehicle. Using a model of the interface 100, the current resistance R_{K} of the interface is estimated therefrom during the current charging process 200. Since the vehicle resistance value R_{B,m} is known, using the current resistance R_{K} an estimated charging device resistance value R_{A,m} depicting the estimated electrical resistance R_{A} of the first interface component A a during the current charging process 200 can be determined.

The estimated vehicle resistance value R_{B,n} and the estimated charging device resistance value R_{A,m} are exchanged during a data exchange 202, and are used as estimated values R_{A,n+1}, R_{B,m+1}, respectively using at least one weighting factor for the updating of the stored resistance values R_{A,n}, R_{B,m}.

In one form, the updated resistance values R_{A,n}, R_{B,m} are sent to a superordinate data processing system. There, using the resistance values R_{A,n}, R_{B,m}, the need for a repair of the interface components A and/or B can be estimated. Likewise, the resistance values R_{A,n}R_{B,m} can be stored in a database, via which, in one form, advantageous pairings of vehicles 110 and charging devices 108 can be sought. Accordingly, a situation in which a vehicle 110 including a comparatively new interface component B is charged on a charging device including a previously damaged interface component A may be inhibited.

In other words, a method for determining the charging contact surface quality or for improving the charging strategy of E-vehicles is presented.

Increasing charging currents in E-vehicles make necessary the precise determining of the quality of contact surfaces that are used for the transmitting of the charging current, in order to inhibit a thermal overloading of the plug connection. Here, the quality of the contact surfaces determines the contact resistances at the plug pins. The temperature of the contacts can be determined conventionally, and the charging current can be reduced in accordance with the determined temperature. However, since the temperature can only be measured with a certain time delay or dead time, the reaction time is limited to a faulty connection, and a thermal overload cannot always be excluded.

In the approach presented here, the measured pin temperature and the measured charging current are used in order to estimate the contact resistance of the current plug connection. This value is continuously updated over the service life of the component, wherein a data exchange between vehicle and charging station is used in order to determine aging phenomena of the contact elements, and thus to determine the share of the contact resistance from the vehicle- and infrastructure-side. Thus for each contact element involved in the charging process, the current surface quality is determined and the charging strategy is predictively adapted. That is, a temperature-dependent derating or a reduction of the maximum charging current does not take place only when an overheating is detected, but rather already beforehand, and thus inhibits an early aging of the intact contact element.

Up to now reactive methods are used in order to reduce an overheating of the plug connection. In one form, the temperature of the contact elements is continuously measured, and a reduction of the charging current is carried out in the event of too-high temperatures. In the event of heavy wear or damage to a contact element, which leads to a significantly increased contact resistance of the plug connection, in one form, with very high charging currents such as 500 A and higher, a temporary overheating and further damage to the contact resulting therefrom cannot always reliably be inhibited. In the worst case even the contacts, e.g., the charging socket, of the vehicle are damaged when they are charged using a heavily worn contact on the infrastructure side. Although the contact resistance can also be determined now, the contact surface state of the charging partner is not known, with the result that an aging-monitoring of its contact is not possible, or at best possible with low accuracy.

Alternatively, a charging socket can be used wherein a particularly rapid and precise temperature measurement is possible. However, the technical implementation of such a temperature measurement is very complex and costly, particularly when high dynamics of the measurement are to be achieved. The integration presented here of the measured data of the charging station can reduce the need for such an expensive solution, since age-related—and thus slowly appearing—degradations of the contacts can be continuously recorded, and the charging strategy can be preemptively adapted. The approach presented here can be integrated, in one form, into future high-power charging infrastructure.

Due to the continuous determining of the “inherent” contact resistance during each charging process, and, in one form, with changing charging partners, damage to intact contact elements during a charging attempt with a damaged charging partner can be inhibited by the charging strategy already being adapted prior to the occurrence of increased temperatures.

For the approach presented here, both parties involved in the charging process exchange the required data via a communication of vehicle and infrastructure. Here the communication can be affected in a wired manner via the interface, and alternatively or additionally wirelessly by radio or via the cloud.

The basis of the method shown here is the determining of contact temperature and charging current both on the vehicle-side and on the infrastructure-side, i.e., at the charging station or wall box. The determining of these values is already affected with high accuracy.

The current measurement in the vehicle is one of the desired parameters to be determined in an E-vehicle. The current measurement on the infrastructure side is required, inter alia, for a precise billing of the costs. (Keyword calibration) The temperature measurement on both sides is a safety-relevant function in order to inhibit an overloading at high charging power. Here the independent measurement of the positive and negative terminal is prescribed by standard.

These measurement values are thus present in the control devices A and B as input for a determining of the contact surface quality. Here the contact surface quality depends directly on the contact resistance at the contact surface between the components A and B.

Subsequently the method can no longer specifically differentiate between vehicle-side and infrastructure-side, since the method can be used on both sides in the same manner. A differentiation can only still be made between the participants of a charging process (A and B).

The contact resistance between the charging contacts of A and B is directly depicted in the temperature measured at the contact. Due to the contact resistance R_{K} between the contacts, a power loss arises during charging that is directly correlated with the charging current I_{A/B}.

P_{Loss}=(I_{A/B})²·(R_{K})

To determine the power loss, a thermal model of the charging system is used that sets the temperature values and the charging current in relation to the power loss. In one form, the heat discharge caused by design, e.g., via an active cooling or via the connected thermal masses, such as cable or vehicle body, is to be taken into account. This behavior can already be determined under controlled conditions during the development of the components involved in the charging process.

By building-in a defined power loss on the contact element, and the measuring of the temporal temperature progression, the derivation of a thermal equivalence circuit, comprised of thermal resistances and capacitances, is possible. This can advantageously be affected at a plurality of locations of the total thermal system. If a sufficiently precisely described thermal equivalent circuit is created, this model can be used, like the approach presented here, to draw conclusions “backwards” from a temperature course about the built-in temperature loss.

Furthermore, to determine the power loss, the charging current of the charging station can be compared to the measured voltage in the vehicle. The voltage difference multiplied by the charging current precisely results in the power loss, but line resistances, in one form, are also measured in this case, so that this voltage measurement alone cannot be used for the calculating of the power loss at the plug contact.

It is assumed that the contact resistance is comprised of surface-specific proportions for the individual contacts.

R_{K}=R_{A}+R_{B}

At the start of the life cycle of a charging contact, its specific proportion of the contact resistance is determined with R_{A,0} or R_{B,0} and is stored as an initial value in the control device of the respective charging participant A or B. If a charging process is now carried out, the contact resistance R_{K} for this one specific charging process is determined on both sides, and the respective stored current specific proportion R_{A} or R_{B} derived therefrom in order to determine an estimated value for the contact resistance of the charging partner.

In one form, it is assumed that A experienced a charging process for the first time (count variable n=0), which means that the initial value R_{A,0} has been stored. For this first charging process, the control device in A determines the total contact resistance R_{A,B,0}^{A} determined via the current I_{A} and the temperature T_{A}. This is comprised of the current stored proportion R_{A,0} and the estimated proportion R_{B,0}.

R_{A,B,0}^{A}=R_{A,0}+R_{B,0}

With the concluding of the charging process, A transmits the estimated proportion to the charging partner B, and in return receives the estimated value R_{A,0} for its own proportion reported back. This process can be referred to as “voting,” since the charging partners mutually agree and evaluate.

The estimated value R_{A,0} is now used by A in order to update its internally stored resistance proportion, whereby the new value R_{A,1} results.

R_{A,1}=R_{A,0}+k·R_{A,0}

Here the factor k serves for normalizing and weighting of the estimated resistance proportion. Since the quality of the current- and temperature-measurement varies with different charging partners, and thus the precision of the estimated resistance proportion can also fluctuate, this estimated value is not adopted without further evaluation. In one form, the actual electrical resistance value is not used, but rather a comparable replacement value that represents the normalized surface quality of the charging contact. The normalization can be depicted, in one form, on a percentage scale with 100%=factory-new contact.

The new resistance proportion R_{A,1} is now stored as current value in the control device of A, and serves in the next charging process (n=1) as basis for the proportion determination. B carries out the same method, so that after the charging process, both participants have carried out an updating of their estimated resistance proportion. With changing charging partners, this method causes the participants to learn from each other and to be able to determine their own resistance proportion with increasing accuracy. As an example, a public rapid charging station can be assumed here that is used daily by different vehicles. An aging-related deterioration of the contact surface quality is thus successively stored in the charging station.

When the charging partners A and B are always the same, the proportions can be distorted, since an aging of A with constant contact quality of B would lead to an equal distribution of the increasing contact resistance on both participants. This is due to the fact that each participant assumes its own contact quality of the previous charging process as the current value. However, if this has dropped since the last charging process, i.e., the proportion of the contact resistance has increased, then this enters directly as an error into the voting, and the inherent resistance increase is attributed to the partner.

With changing charging partners such extreme cases are compensated, since such errors do not sum up, but rather are distributed over the larger number of charging partners and are equally compensated for by them. A significant aging of the contacts between two charging processes is regarded as an extreme case. Alternatively, an adapting of the weight factor k is possible, which is reduced with repeated charging with the same charging partner, so that a corresponding error does not increase with each charging cycle.

The method thus represents a possibility to determine, over the service life, the aging phenomena of the respective contact surface for each charging contact wherein the temperature and the current can be specifically determined, e.g., DC+ and DC− with direct current charging.

This is advantageous in one form with the scenario of a new E-vehicle including correspondingly new charging contacts. The vehicle is charged at a heavily used public charging station. It is assumed that the contacts of the charging station already contribute a greatly increased contact resistance, and thus with charging at high power, in one form, 500 A high-power charging, a very rapid heating of all charging contacts occurs. Since a highly dynamic temperature measurement of charging contacts is currently only inadequately possible, the temperature increases very quickly at the charging contacts, in one form directly at the contact surface, which, however can only be recorded with a certain temporal delay and reduced dynamics by the integrated temperature measuring. The measured temperature increase at the sensor thus does not correspond to the temperature increase at the contact point, and the measured temperature at the sensor is also, under certain circumstances, significantly below the temperature at the contact point. If the sensor value is now reacted to, and the charging current is reduced according to a measured temperature increase, the temperature at the contact point can already be significantly higher, and a thermally induced aging of the contact elements can already have occurred. For the new vehicle, this means a premature aging of the charging contacts due to the lack of knowledge about the increased resistance proportion of the charging partner. In this case the reactive charging strategy could thus not prevent a damaging/unnecessary aging of the charging contacts.

Using the method presented, it is now possible that the participants A and B previously exchange about the quality of their charging contacts, and the charging strategy is thus preemptively adapted in order to inhibit from the outset a thermal aging of the factory-new contacts.

In one form, the same communication interface can be used that is also required for the voting. In one form, both a direct communication between the charging partners (in one form, via powerline communication, CAN or NFC) and a cloud-based communication are conceivable. In the case of the latter variant, the taking into account of the contact quality would already by possible while seeking a suitable charging station.

Furthermore, the method offers a suitable input for predictive maintenance approaches wherein the charging contacts of a charging station can already be exchanged before they can lead to thermal overloads.

Since the above-described devices and methods described in detail are forms and variations, they can be modified in a conventional manner by the person skilled in the art to a wide extent without leaving the field of the invention. In one form, the mechanical assemblies and the size ratios of the individual elements with respect to one another are only chosen by way of example.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for charging an electrically powered vehicle, the method comprising:
predetermining a maximum charging current of a charging process for charging the electrically powered vehicle before a start of a charging process based on an electrical resistance of at least one interface component of an interface between a charging device and the electrically powered vehicle, wherein the electrical resistance is determined during at least one previous charging process; and
charging the electrically powered vehicle based on the predetermined maximum charging current.

2. The method according to claim 1, wherein the maximum charging current is predetermined based on a resistance of at least one interface component of the charging device and a resistance of at least one interface component of the vehicle.

3. The method according to claim 1, wherein a resistance determination for determining a current electrical resistance of the interface is carried out via the interface during a current charging process using a current temperature of the interface and a current charging current.

4. The method according to claim 3, further comprising determining the resistance of the interface using a vehicle resistance value, provided by the vehicle, representing an estimated electrical resistance of an interface component of the vehicle, and a charging device resistance value, provided by the charging device, representing an estimated electrical resistance of an interface component of the charging device.

5. The method according to claim 4 further comprising estimating the current electrical resistance of the interface component of the vehicle using the current electrical resistance of the interface and of the charging device resistance value of the at least one previous charging process stored in the charging device.

6. The method according to claim 5, further comprising updating the vehicle resistance value stored in the vehicle during the current charging process using the estimated electrical resistance of the interface component of the vehicle.

7. The method according to claim 4, further comprising estimating the current electrical resistance of the interface component of the charging device using the current electrical resistance of the interface and of the vehicle resistance value, stored in the vehicle, of the at least one previous charging process.

8. The method according to claim 7, further comprising updating the charging device resistance value stored in the charging device during the current charging process using the estimated electrical resistance of the interface component of the charging device.

9. A control device configured to perform the method according to claim 1.

10. A computer program product executable by a processor to perform the method according to claim 1.

11. A machine-readable storage medium configured to store the computer program product according to claim 10.
